(19) United States
(12) Patent Application Publication
(10) Pub. No.: US 2024/0335857 A1
(43) Pub. Date: Oct. 10, 2024

(54) DIRECTIONAL AIR KNIFE

(71) Applicant: A. G. Stacker Inc., Weyers Cave, VA (US)

(72) Inventors: Dalton HEGE, Weyers Cave, VA (US); Randall Donn SENGER, Mount Sidney, VA (US); Eric STEMPIHAR, Rockingham, VA (US); Joseph WUNDER, Lexington, VA (US)

(21) Appl. No.: 18/743,684

(22) Filed: Jun. 14, 2024

Related U.S. Application Data
(63) Continuation of application No. 18/468,921, filed on Sep. 18, 2023.
(60) Provisional application No. 63/408,291, filed on Sep. 20, 2022.

(51) Int. Cl. B07B 4/00; B07B 13/16

(52) U.S. Cl. CPC B07B 4/00; B07B 13/16

(57) ABSTRACT

An air knife includes a housing having a first end, a second end spaced from the first end in a longitudinal direction, a side wall extending from the first end to the second end, an interior, an entrance aperture configured to be connected to a source of pressurized air to increase a pressure of air inside the housing and an exit aperture. A nozzle is located at the exit aperture and has a nozzle inlet in fluid communication with the exit aperture and also has a nozzle outlet. A plurality of baffles are located in the interior of the nozzle, and each of the baffles is angled relative to the longitudinal direction. Also an assembly of a plurality of the air knives.

### CROSS-REFERENCE

The present application is a continuation-in-part of U.S. Ser. No. 18/468,921, filed Sep. 18, 2023, now pending, which claims the benefit of U.S. Provisional Patent Application No. 63/408,291, filed Sep. 20, 2022, the entire contents of which are hereby incorporated by reference.

### TECHNOLOGICAL FIELD

The present disclosure is directed to an air knife having baffles or other structure to change the direction of air exiting the air knife.

### BACKGROUND

Air knives are known that comprise a tube having a slit-like opening. Pressurized air is fed into the tube from a blower or source of compressed air so that the air exits the opening in a sheet at high speed. Such air knives are commonly used to clean and/or dry materials moving past the air knife on a conveyor. U.S. Pat. No. 6,742,285, which is incorporated herein by reference, shows a general example of an air knife.

Air knives are currently used above conveyors to dislodge scrap from sheets of material, such as paperboard, carried by the conveyors. These air knives are mounted across the conveyor so that they extend perpendicular to the direction of sheet movement along the conveyor. Air knives mounted in this manner tend to blow scrap toward the entrance to the conveyor, but due to the small spacing between the sheets on the conveyor, they do not always blow the scrap off the sheets. Instead, scrap may be blown backward onto upstream sheets. Mounting an air knife at an angle to the sheet travel direction as shown in U.S. Pat. No. 6,742,285 for example, might be useful in some circumstances; however, in many conveyors there is no room to mount an air knife as taught in this reference.

### SUMMARY

The air knife of the present disclosure is intended to be used in a conveyor for moving sheets of corrugated paperboard from a die cut machine to a stacker. The air knife is configured to blow scrap at an angle to the sheet travel direction while the air knife itself is mounted substantially perpendicular to the sheet travel direction. This is accomplished by providing air guides or baffles in or at the opening of the air knife to direct air exiting the air knife at an angle to the sheet travel direction. Optionally, the baffles may be movable to change the angle of the exiting air.

A first aspect of the disclosure is an air knife comprising a tubular housing having a first end, a second end spaced from the first end in a longitudinal direction, a side wall extending from the first end to the second end, an interior, and an aperture configured to be connected to a source of pressurized air to increase a pressure of air inside the tubular housing. There is at least one opening in the side wall of the housing, and a nozzle is located at the at least one opening. The nozzle has a nozzle inlet in fluid communication with the at least one opening, a nozzle outlet spaced from the nozzle inlet, and a nozzle interior. A plurality of baffles are located in the nozzle interior, each of the baffles having a first end at the nozzle inlet and a second end at the nozzle outlet. The tubular housing is divided into a first half and a second half by an imaginary plane perpendicular to the longitudinal direction, and the second end of each of the baffles is longitudinally offset from the first end of each of the baffles.

Another aspect of the disclosure is an air knife comprising a tubular housing having a first end, a second end spaced from the first end in a longitudinal direction, a side wall extending from the first end to the second end, an interior, and an aperture configured to be connected to a source of pressurized air to increase a pressure of air inside the tubular housing. There is at least one opening in the side wall of the housing, and a nozzle is located at the at least one opening. The nozzle has a nozzle inlet in fluid communication with the at least one opening, a nozzle outlet spaced from the nozzle inlet, and a nozzle interior. A plurality of baffles are located in the nozzle interior, each of the baffles having a first end at the nozzle inlet and a second end at the nozzle outlet. The tubular housing is divided into a first half and a second half by an imaginary plane perpendicular to the longitudinal direction, and the baffles are configured such that when the pressure of the air inside the tubular housing is greater than a pressure of air outside the tubular housing air exits the nozzle outlet at an acute angle relative to the plane.

Yet another aspect of the disclosure comprises an air knife with at least one housing having a first end, a second end spaced from the first end in a longitudinal direction, a side wall extending from the first end to the second end, an interior, an entrance aperture configured to be connected to a source of pressurized air to increase a pressure of air inside the housing and an exit aperture. A nozzle is mounted or formed at the exit aperture, and the nozzle has a nozzle inlet in fluid communication with the exit aperture, a nozzle outlet spaced from the nozzle inlet, and a nozzle interior. A plurality of baffles are located in in the nozzle interior, and each of the baffles has a first end at the nozzle inlet and a second end at the nozzle outlet. Each of the baffles is angled relative to the longitudinal direction.

A further aspect of the disclosure comprises an air knife assembly having a conduit having at least one wall and a plurality of openings in the at least one wall and at least one air knife connected to the conduit. The air knife assembly comprises a first air knife having a first housing having an entrance aperture connected to a first one of the plurality of openings and having an exit aperture, and a first nozzle having an interior, an inlet in fluid communication with the exit aperture of the first housing, and a plurality of first baffles in the interior of the first nozzle and angled in a first direction, and a second air knife having a second housing having an entrance aperture connected to a second one of the plurality of openings and having an exit aperture, and a second nozzle having an interior, an inlet in fluid communication with the exit aperture of the second housing, and a plurality of second baffles in the interior of the second nozzle angled in a second direction.

### BRIEF DESCRIPTION OF THE DRAWINGS

FIG. 1 is a end elevational view, partly in section, of a sheet of material supported by a conveyor beneath an air knife having a nozzle according to a first embodiment of the present disclosure.

FIG. 2 is a sectional view taken in the direction of line 2-2 in FIG. 1.

FIG. 3 is a perspective view of a first embodiment of a baffle assembly mountable in the nozzle of the air knife of FIG. 1.

FIG. 4 is an elevational view of the baffle assembly of FIG. 3.

FIG. 5 is an elevational view of one of the baffles of the baffle assembly of FIG. 4.

FIG. 6 is a sectional view through an air knife according to a second embodiment of the present disclosure.

FIG. 7 is a perspective view of a baffle assembly of the air knife of FIG. 6.

FIG. 8 is an elevational view of the baffle assembly of FIG. 7.

FIG. 9 is an elevational view of one of the baffles of the baffle assembly of FIG. 7.

FIG. 10 is a sectional view through an air knife according to a third embodiment of the present disclosure.

FIG. 11 is a perspective view of the baffle assembly of FIG. 10.

FIG. 12 is an elevational view of the baffle assembly of FIG. 11.

FIG. 13 is an elevational view of one of the baffles of the baffle assembly of FIG. 11.

FIG. 14 is a sectional view through an air knife according to a fourth embodiment of the present disclosure.

FIG. 15 is a perspective view of the baffle assembly of FIG. 14.

FIG. 16 is an elevational view of the baffle assembly of FIG. 15.

FIG. 17 is an elevational view of one of the baffles of the baffle assembly of FIG. 15.

FIG. 18 is an elevational view of a fifth embodiment of an air knife according to the present disclosure.

FIG. 19 is a sectional view taken in the direction of line 19-19 in FIG. 18.

FIG. 20 is a sectional view taken in the direction of line 20-20 in FIG. 19.

FIG. 21 is a detail view of region 21 in FIG. 20.

FIG. 22 is a detail view of region 22 in FIG. 20.

FIG. 23 is a perspective view of the air knife of FIG. 18.

FIG. 24 is an exploded view of the air knife of FIG. 23.

FIG. 25 is an end elevational view of the air knife of FIG. 23.

FIG. 26 is a sectional view of a first baffle configuration for the nozzle of the air knife of FIG. 18.

FIG. 27 is a view taken in the direction of line 27-27 in FIG. 26.

FIG. 28 is a sectional view of a second baffle configuration for the nozzle of the air knife of FIG. 18.

FIG. 29 is a view taken in the direction of line 29-29 in FIG. 28.

FIG. 30 is a sectional view of a third baffle configuration for the nozzle of the air knife of FIG. 18.

FIG. 31 is a view taken in the direction of line 31-31 in FIG. 30.

FIG. 32 is a perspective view of the external air guide of FIG. 18.

FIG. 33 is a sectional view through a fourth baffle configuration in which the angle of the baffles changes over the length of the air knife.

FIG. 34 is an exploded perspective view of a nozzle according to a sixth embodiment in which the angle between the baffles and the nozzle outlet of the air knife is adjustable.

FIG. 35 is an elevational view of one of the baffles of FIG. 34.

FIG. 36 is a side elevational view of a conveyor having an upper deck and a lower deck and two air knife assemblies according to aspects of the present disclosure mounted to the upper deck.

FIG. 37 is a perspective view of a first embodiment of one of the air knife assemblies of FIG. 36.

FIG. 38 is a sectional elevational view taken along line 38-38 of FIG. 37.

FIG. 39 is a front elevational view, partly in section, of the air knife assembly of FIG. 36 mounted on the upper deck of the conveyor of FIG. 36.

FIG. 40 is a side elevational view of an air knife assembly and a portion of the upper conveyor deck of FIG. 36.

FIG. 41 is a side elevational view of two air knife assemblies according to the present disclosure mounted to the upper deck of the conveyor of FIG. 36.

FIG. 42 is a perspective view of a second embodiment of one of the air knife assemblies of FIG. 36.

FIG. 43 is a sectional elevational view of the air knife assembly of FIG. 42.

FIG. 44 is sectional elevational view of the air knife assembly of FIG. 42 mounted to the upper conveyor deck of FIG. 36 showing the relationship between individual air knives and belts of the upper conveyor deck.

### DETAILED DESCRIPTION

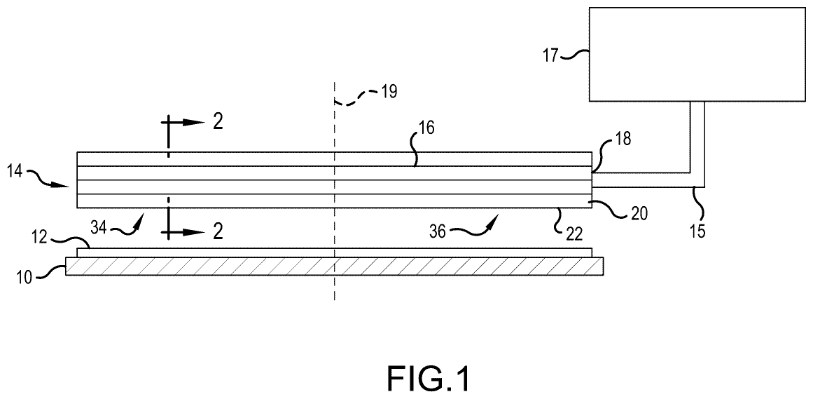

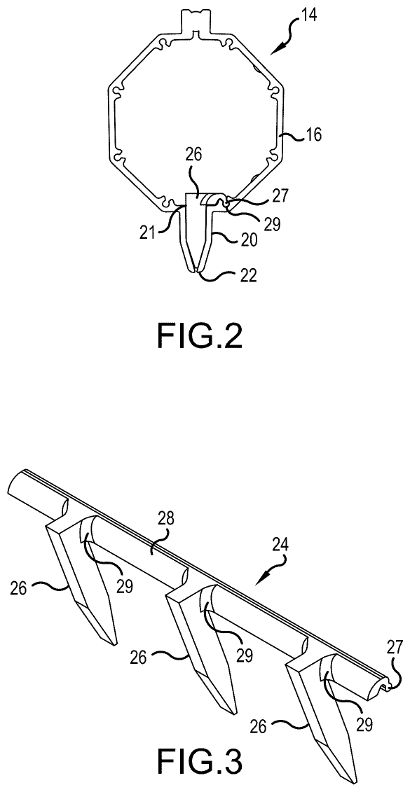

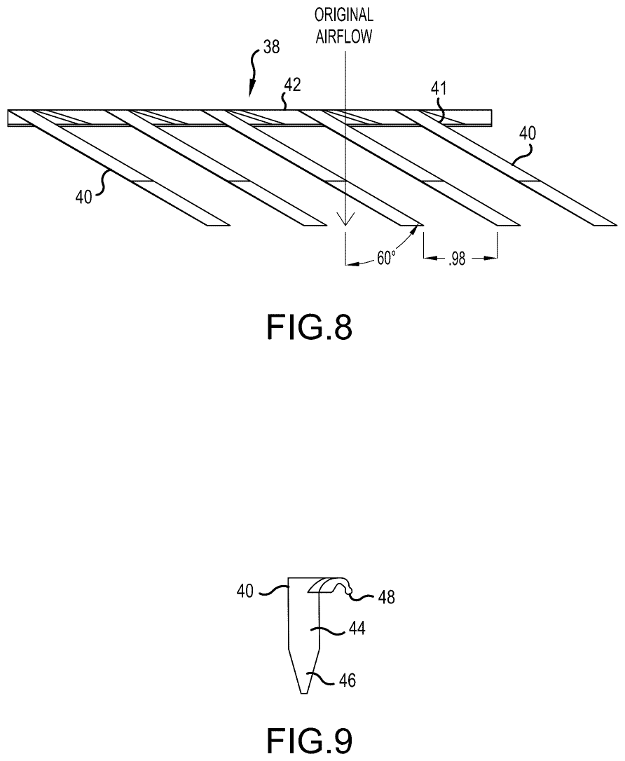

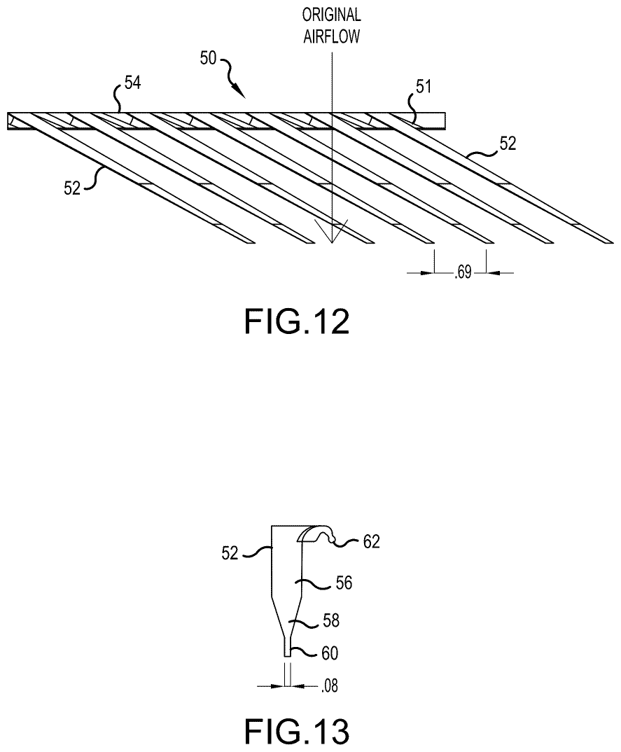

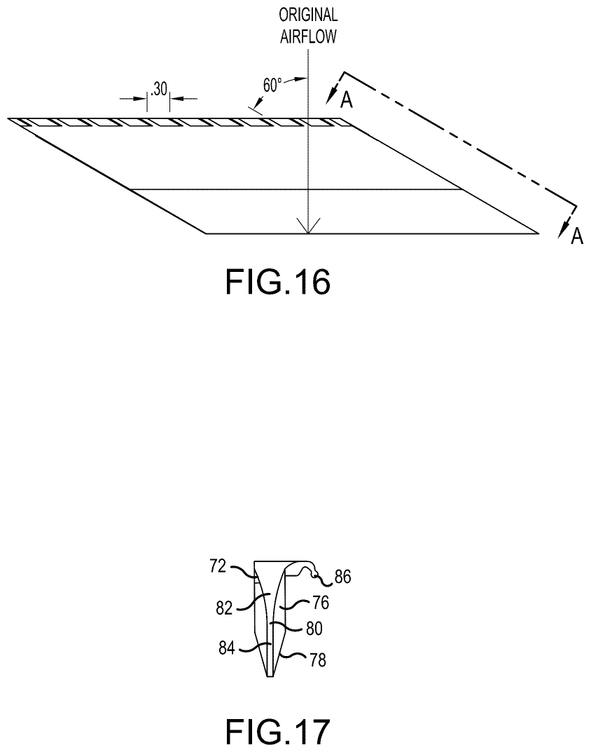

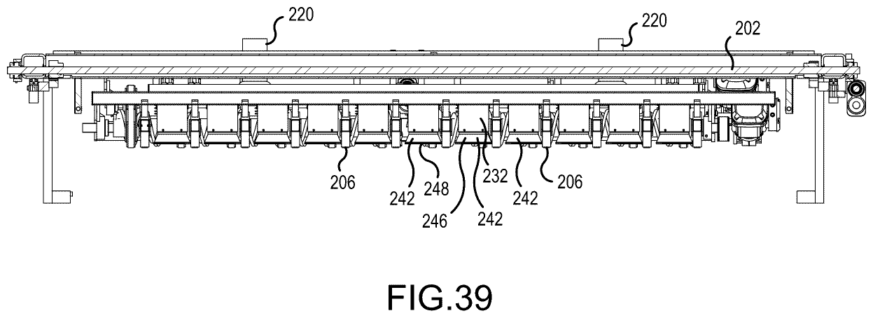

Referring now to the drawings, wherein the showings are for purposes of illustrating presently preferred embodiments of the present invention and not for the purpose of limiting same, and wherein FIGS. 2-44 are drawn to scale, FIG. 1 shows a conveyor 10 supporting a sheet of material 12, such as corrugated paperboard, as it passes beneath an air knife 14. The conveyor 10 moves in a downstream or sheet-transport direction, and the air knife 14 is mounted perpendicular to the sheet transport direction. That is, the length direction or longitudinal direction of the air knife is perpendicular to the downstream direction.

The air knife 14 includes a tubular housing 16 connected to a blower 17 or other source of pressurized air by a single connector 15 attached to an aperture 18 in the tubular housing 16 as illustrated in FIG. 1. In the alternative (not illustrated), the source of pressurized air may be connected to both ends of the tubular housing. As used herein, “source of pressurized air” can mean a fan or blower 17 for driving air into the tubular housing 16 to increase the air pressure inside the tubular housing or a cylinder of compressed air (not illustrated) connected to the tubular housing to increases the pressure in the tubular housing 16. The tubular housing 16 is divided into two halves by an imaginary plane 19 perpendicular to the longitudinal direction of the tubular housing.

As shown in FIG. 2, the housing 16 includes an elongated nozzle 20 having a nozzle inlet 21 in fluid communication with the interior of the housing 16 and a slit-shaped nozzle outlet 22 through which pressurized air passes before impacting against the sheet of material 12 on the conveyor 10. In this embodiment, the nozzle 20 and the housing 16 are formed as one piece. The relatively narrow width of the nozzle outlet 22, which is narrower than the width of the nozzle inlet 21, increases the speed of the air exiting the air knife 10 to form a sheet of air that impacts against the sheet of material 12 and dislodges scrap resting on the sheet of material 12. A second air knife (not illustrated) may also be provided below the conveyor 10 to blow air on the conveyor bottom (assuming the conveyor is formed from multiple parallel belts or has gaps or openings) to dislodge scrap attached to the bottoms of the sheets of material 12. The second air knife may be identical to the first air knife and will not be further described.

For the air knife of the present disclosure, the speed and volume of air emitted from the nozzle 20 should be sufficiently high that loose and partially attached chads (scrap material partially attached to the sheets of material on the conveyor 10) can be moved to the sides of the conveyor without damaging the sheets of material themselves.

The housing 16 and the nozzle 20 preferably extend perpendicular to the shect transport direction, and the nozzle 20 may be tilted (that is, the housing 16 may be rotated around its longitudinal axis) so that the nozzle 20 faces upstream at an angle of, for example, 30 degrees while the longitudinal direction of the nozzle 20 remains perpendicular to the sheet transport direction. It is sometimes desirable to direct the nozzle 20 at an angle to the sheet transport direction (so that the housing 16 is not perpendicular to the sheet transport direction) to impart transverse movement to scrap on the sheets of material 12 to better move the scrap toward and/off the edges of the sheets of material 12. This can be done by mounting the entire housing 16 at an angle to the sheet transport direction; however, many conveyors do not have sufficient space to allow for an angled mounting. Embodiments of the present disclosure address this problem by providing baffles or vanes to direct the air exiting the housing 16 at an angle to the sheet transport direction while the housing of the air knife remains perpendicular to the sheet transport direction.

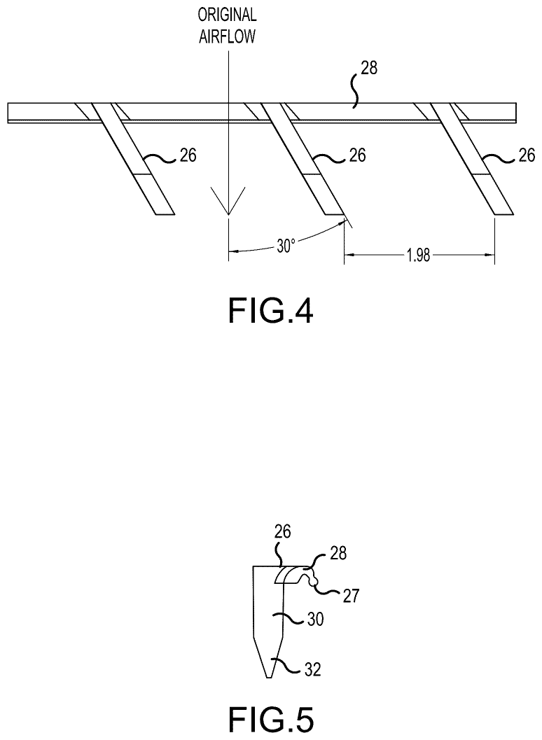

In a first embodiment, at least one baffle assembly 24, which includes a plurality of individual baffles 26, is provided in the interior of the nozzle 20 with a first end of each baffle located near the nozzle inlet 21 and a second end of each baffle near the nozzle outlet 22. The baffles 26 may be located entirely inside the nozzle 20; in the alternative, the first ends of the baffles may extend into the interior of the tubular housing 16 and/or the second ends of the baffles may project out of the nozzle outlet 22. The sectional view of FIG. 2 shows one of the baffles 26, and FIGS. 3 and 4 show the baffles 26 supported by a common baffle support member 28.

Each of the baffles 26 includes a main portion 30 and a tapered distal portion 32 which is shaped to conform to the interior of the nozzle 20 and span a portion of the interior so that air from the housing 16 exits the air knife 10 between adjacent pairs of the baffles 26. The baffle support member 28 includes a profiled bead 27 configured to be received in a channel 29 in the interior of the housing 16 to secure the baffle assembly 24 in a desired position and orientation relative to the nozzle outlet 22. If the baffles 26 were not present, air exiting the nozzle 20 would flow perpendicular to the longitudinal axis of the housing 16 (the original air exit direction). The baffles 26 are shaped such that the second end of each baffle is longitudinally offset from the first end of each baffle and thus angled such that air exiting the air knife 14 flows toward one side (if all baffles are angled in the same direction) or both sides (if two sets of the baffles 26 are angled in opposite direction) of the air knife 10 and thus toward one or both sides of a centerline of the conveyor 10. In some cases, the baffles 26 can be curved instead of flat as illustrated. When flat baffles 26 are discussed, the baffles may be described as being “angled” relative to an original airflow direction perpendicular to the longitudinal center line of the tubular housing 16; this disclosure applies to curved baffles as well.

The baffle assembly 24 is preferably formed from plastic, but can also be formed from metal or other materials. In particular when formed from plastic, the baffle assembly 24 can be 3D printed or formed by another additive manufacturing process. In addition, conventional molding methods can be used.

The number and spacing of the baffles 26 can vary as can the angle of the baffles 26 relative to the original air exit direction. FIG. 4 shows the baffles 26 making a 30 degree angle relative to the original air exit direction; however, the baffles 26 may be directed at angles of about 30 to 60 degrees relative to the original exit direction. The angle selected may be based on the amount of air flow through the nozzle 20 and/or the amount and/or type of scrap that needs to be dislodged from the sheets of material 12. Larger or smaller numbers of baffles may also be used.

Referring again to FIG. 1, the baffles 26 can be arranged such that they are all angled toward one side of the conveyor 10-to the right in FIG. 1, for example. However, preferably, a first set 34 of the baffles 26 is angled away from the center plane 19 of the air knife 14 toward the left side of the conveyor 10, and a second set 36 of the baffles 26 is angled away from the center plane 19 of the air knife 14 toward the right side of the conveyor 10. With this configuration, scrap on the upper surface of the sheet of material 12 only needs to be moved at most across half the width of the sheet of material 12 before falling off a side edge. The baffles 26 each include a curved portion 29 where they connect to the baffle support member 28 to help guide air into the spaces between the baffles 26. The length of the curved portion 29 can be made longer or, optionally, the baffle 26 itself can be curved along some or all of its length.

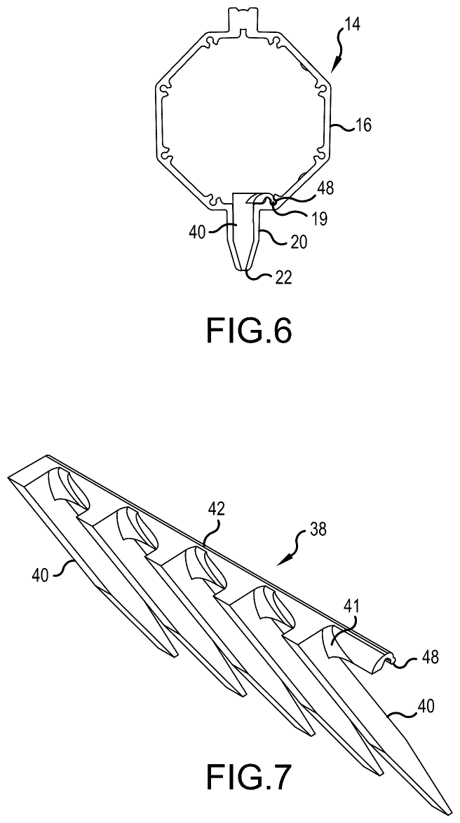

FIGS. 6-9 show a second embodiment of a baffle assembly 38 mounted in the tubular housing 16 which includes a plurality of individual baffles 40 attached to a common baffle support member 42 with a curved air guide wall 41 provided at the connection of each of the baffles 40 and the baffle support member 42. The baffles 40 are angled at 60 degrees relative to the original exit direction of air from the nozzle 20 and are more closely spaced (e.g., by about 1 inch) than the baffles 26 of the baffle assembly 24 of the first embodiment (which are spaced by about 2 inches). Each of the baffles 40 includes a main portion 44 and a tapered distal portion 46 which are shaped to conform to and span the interior of the nozzle 20. The baffle support member 42 includes a profiled bead 48 that is receivable in the channel 29 inside the housing 16 to hold the baffle assembly 38 in position.

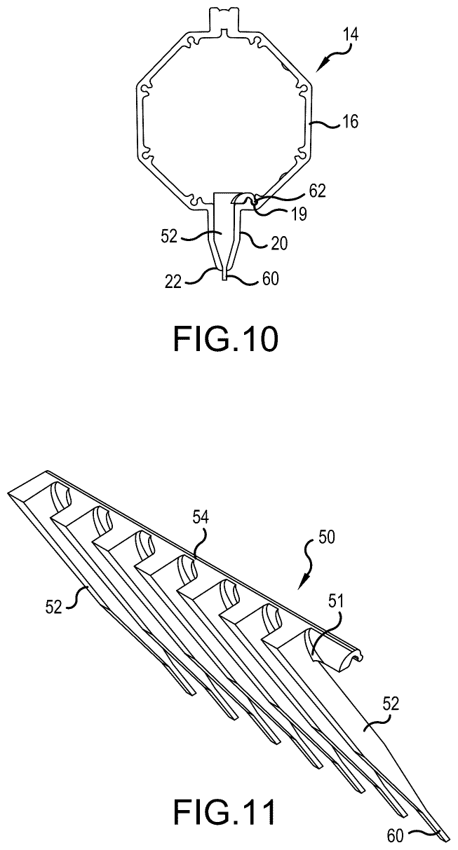

FIGS. 10-13 show a third embodiment of a baffle assembly 50 mounted in the tubular housing 16 which assembly includes a plurality of individual baffles 52 attached to a baffle support member 54 with a curved air guide wall 51 at the connection of each baffle 52 to the support member 54. The baffles 52 are angled at about 60 degrees to the original exit direction of air from the nozzle 20 and are more closely spaced (by about 0.69 inches) than the baffles 26 and 40 of the first and second embodiments. Each of the baffles 52 has a main body portion 56 and a tapered distal portion 58, and the baffles 52 are shaped to conform to and span the interior of the nozzle 20. Furthermore, in this embodiment, the tips 60 of the distal portions 58 of the baffles 52 project through the nozzle outlet 22 as shown in FIG. 10, which may sometimes provide improved directional control of the air flow. The baffle support member 54 also includes a profiled bead 62 that is receivable in the channel 29 in the housing 16 to hold the baffle assembly 50 in place.

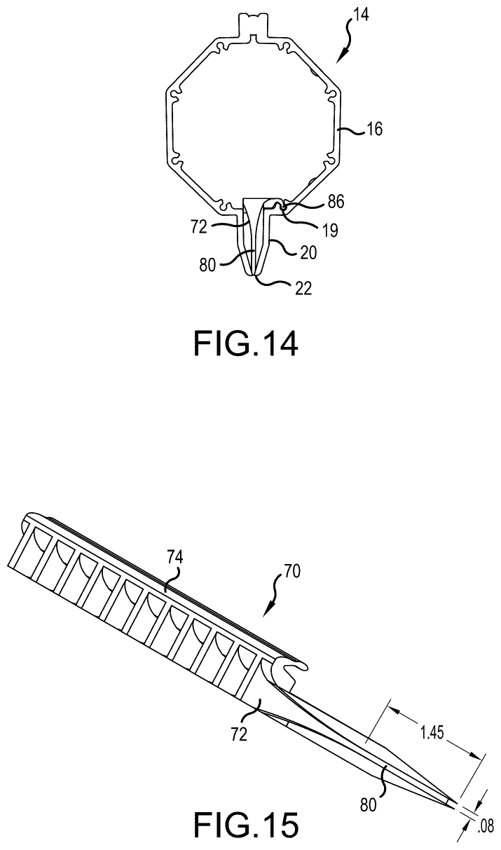

FIGS. 14-17 show a fourth embodiment of a baffle assembly 70 that includes a plurality of individual baffles 72 attached to a baffle support member 74 and mounted in the tubular housing 16 at a space of about 0.3 inches. The baffles 72 are angled at about 60 degrees to the original air exit direction from the nozzle 20. Each of the baffles 72 has a main body portion 76 and a tapered distal portion 78 shaped to span the width of the nozzle 20. Each of the baffles 72 also includes a center rib 80 on one side thereof which rib 80 includes a tapering upper portion 82 and a thin lower portion 84 having a substantially constant width. The rib 80 may help to improve the uniformity of air flow exiting the slit 22. The baffle support member 74 also includes a profiled bead 86 that is received in the channel 29 of the housing 16 to hold the baffle assembly 70 in place.

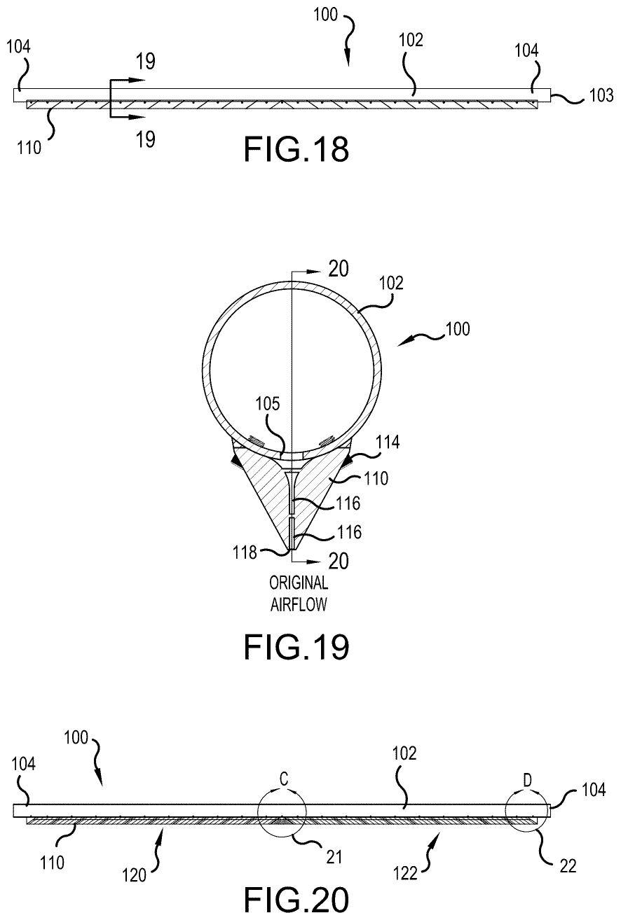

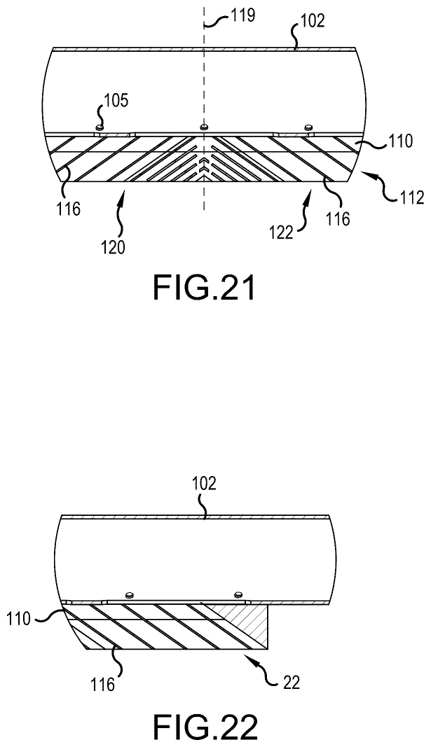

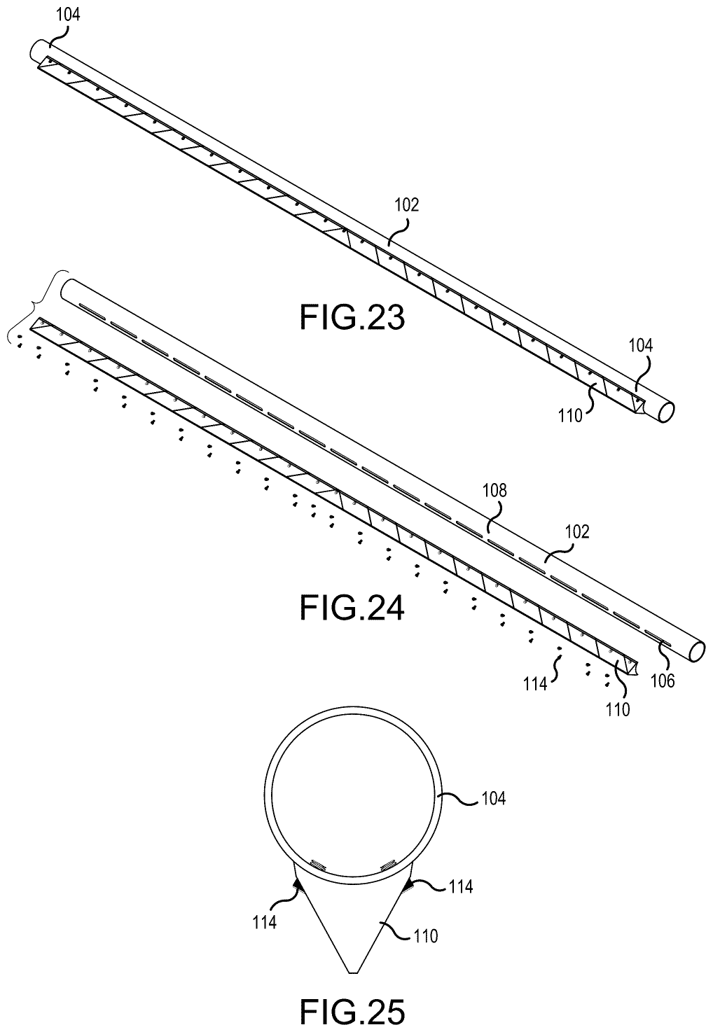

FIGS. 18-33 show a second embodiment of an air knife 100 according to the present disclosure. In this embodiment, as can be seen in FIGS. 20 and 21, for example, baffles are formed in a nozzle structure that is attached to a tubular housing rather than being located in a nozzle 20 that is formed integrally with a housing 16 as shown in the first embodiment. Referring now to the air knife 100 of FIG. 18, (shown in perspective view in FIG. 23 and exploded in FIG. 24), the air knife 100 includes a tubular housing 102 having longitudinally spaced ends 104 either or both of which includes an aperture 103 that is connectable to a blower or other source of pressurized air (not illustrated). The housing 102 includes a plurality of holes 105 (FIG. 21) or slots 106 (FIG. 24) in its cylindrical side wall 108, but a single slot 106 or a greater or lesser number of holes 105 and/or slots 106 could be provided. The slots 106 allow pressurized air to exit the housing 102.

A nozzle 110 is connected to the housing 102 such that the slots 106 of the housing are in fluid communication with an interior 112 of the nozzle 110. The nozzle 110 may be attached to the housing 102 by a plurality of screws 114 as illustrated in the drawings or by welding or the use of an adhesive or other suitable fastening method. Baffles 116 inside the nozzle 110 direct air exiting the nozzle 110 at an angle to the sheet transport direction. That is, if the baffles 116 were not present, air would exit through the nozzle outlet 118 at the end of the nozzle 110 in a direction perpendicular to the longitudinal direction of the housing 102; the baffles 116 direct the exiting air at an angle to that perpendicular direction. The baffles 116 are preferably molded from the same material used to form the nozzle 110; in the alternative, they can be attached to or formed on the surface of the nozzle after the nozzle 110 is produced.

Referring now to FIG. 21, which shows a detail of the portion of the nozzle 110 located in the center of the housing 102, a first set 120 of the baffles 116 are angled to the left of the center plane 119 in the figure while a second set 122 of the baffles 110 are angled to the right of the center plane 119. FIG. 22, a detail view of the right end of the nozzle 110 of FIG. 17, show baffles 116 of the second set 122 of baffles. The nozzle 110 thus emits streams of air in opposite directions, away from the center plane 119 of the air knife 100 to blow scrap toward the opposite sides of sheets of material 12 on a conveyor beneath the air knife 100. The baffles 116 could alternately be angled to direct exiting air toward the center plane 119 of the of the air knife 100, for example, if two sheets are being carried along the conveyor with a gap in between the sheets or if another reason exists to move scrap toward the center of the conveyor 10.

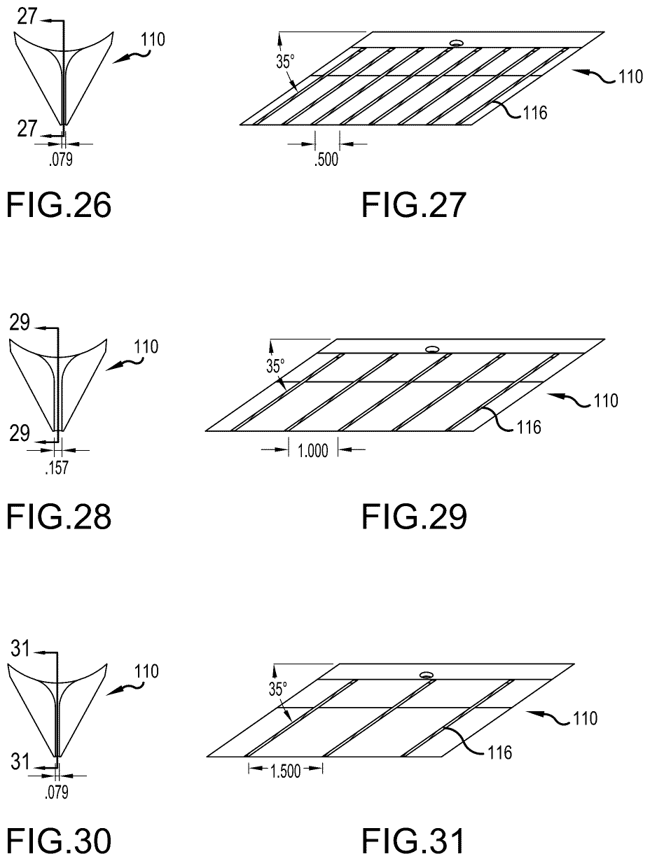

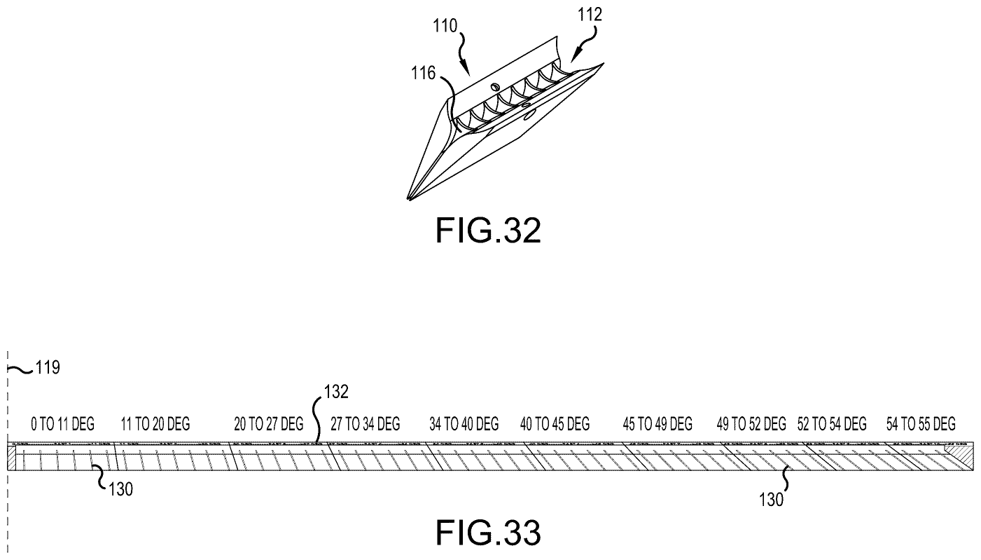

FIGS. 26-32 show different configurations of the baffles 116 inside embodiments of the nozzle 110. The baffles 116 and the interior 112 of the nozzle 112 can also be seen in FIG. 32.

FIG. 33 shows an alternate arrangement of baffles 130 inside a nozzle 132. As can be seen in FIG. 33, the angle between the baffles 130 and the center plane 119 increase from the center to the each edge of the nozzle 132 (FIG. 33 only shows one half of the nozzle 132). In FIG. 33, the angle of each baffle 130 is different than the angle of an adjacent baffle so that the baffle angle changes from about 0 degrees at the center of the nozzle 130 (that is, air in the center of the baffle is directed straight down in the original air exit direction) and air at the extreme right end of the nozzle 132 is angled at about 55 degrees.

The angle of each baffle can be different, as shown, or several baffles may be angled at the same angle. For example, although not illustrated, a first subset of, e.g., five baffles can be angled at 10 degrees, a next subset of five baffles can be angled at 20 degrees, etc. from the center plane 119. Finally, in some instances, it may be desirable to decrease the angle of the baffles from the center of the nozzle 132 to each end of the nozzle 132 so that, for example, the baffles near the center of the nozzle 132 make an angle of 60 degrees to the original air exit direction and the angle of the baffles at the edges of the nozzle 132 is, e.g., 30 degrees.

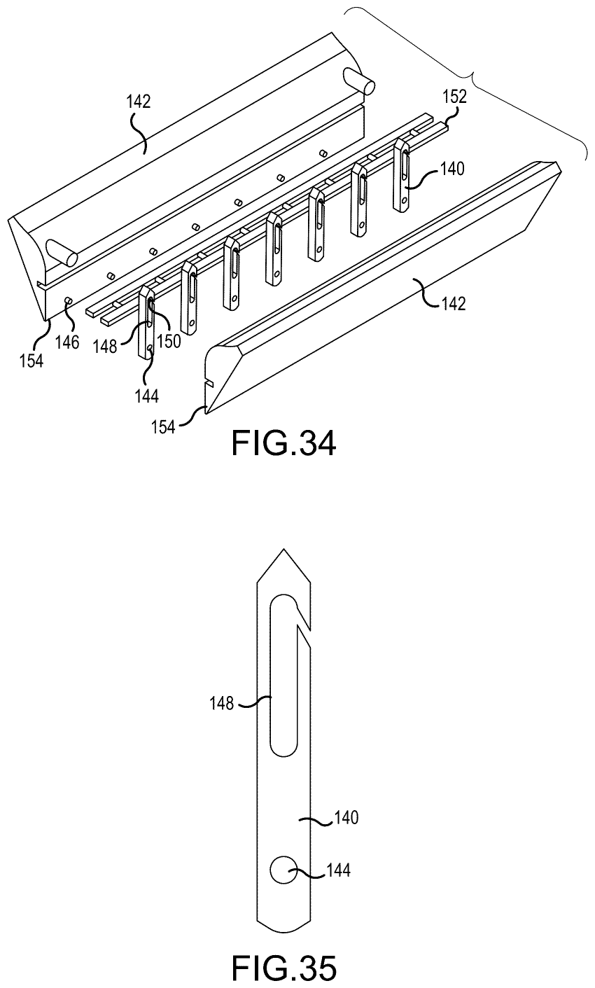

FIG. 34 shows a nozzle according to a further embodiment of the disclosure in which the baffles 140 in a nozzle 142 are adjustable from 0 degrees to a maximum angle of, for example, 60 degrees either toward or away from a center plane or an end of a housing. This is accomplished by providing the baffles 140, one of which is shown by itself in FIG. 35, with a bottom opening 144 by which a lower end of the baffle 140 is pivotably mounted to a pin 146 in the interior of the nozzle 142 while a second end of the baffle 140 includes a slot 148 in which a pin 150 of an actuator in the form of a slider 152 is received. Moving the slider 152 back and forth, either manually or by an actuator (not illustrated) changes the angle between the baffles 142 and the exit 154 of the nozzle 142. This may be useful, for example, when it is sometimes desirable to allow air to exit the nozzle 142 in the original air exit direction (with the baffles perpendicular to the nozzle exit 154) and sometimes desirable to direct the air from the nozzle 142 at a positive or negative angle.

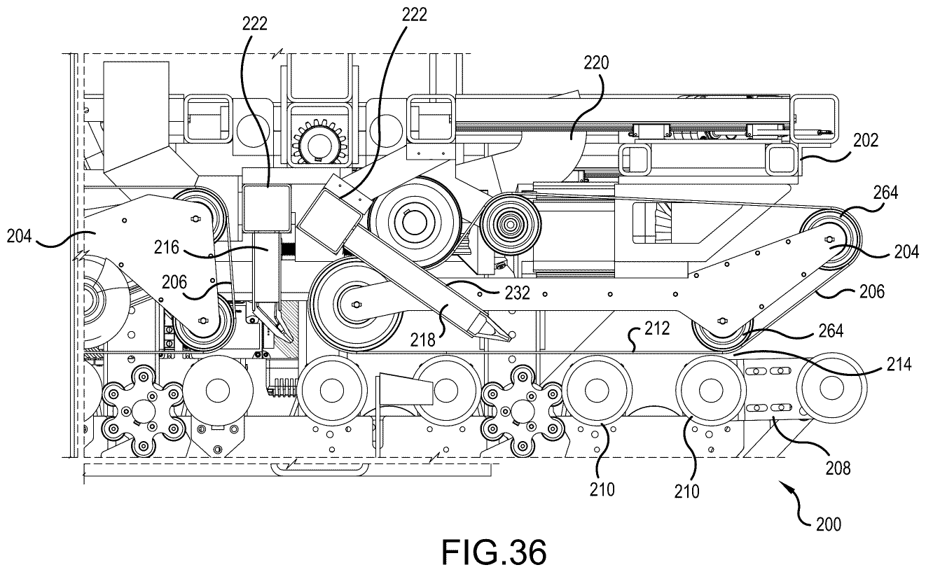

Additional embodiments of air knives and air knife assemblies are shown in FIGS. 36-44. FIG. 36 shows a conveyor 200 having an upper deck 202 that includes a plurality of belt support assemblies 204 each supporting an individual belt 206 and also shows a lower deck 208 with a plurality of support wheels 210. The lower runs 212 of the belts 206 and the tops of the support wheels 210 define a sheet transport path 214 or boardline along which sheets of material travel through the conveyor 200 in a sheet transport direction, which is a right-to-left direction in FIG. 36. The tops of the support wheels 210 are tangent to a plane. The lower runs 212 of the belts 206 in many cases are located above the plane, but in some cases, when the support wheels 210 are laterally offset from the belts 206, the lower runs of the belts 206 may be located at or beneath the plane so that sheets of material moving through the conveyor 200 are slightly flexed which, in some applications, provides for better control of the sheets.

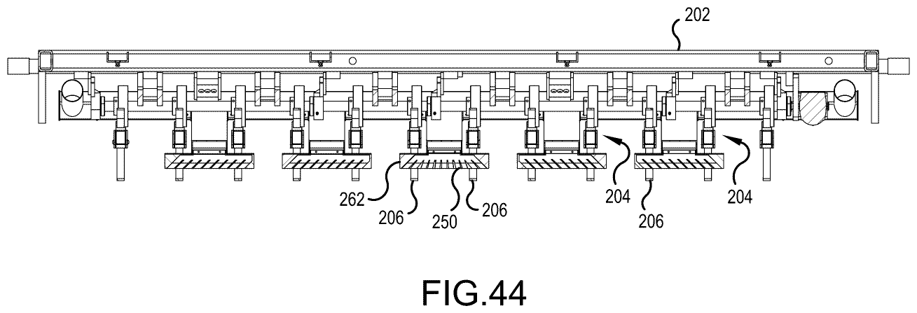

The belt support assemblies 204 are mounted adjacent to each other in a transverse direction perpendicular to the sheet transport direction to form rows, and the upper deck 202 may include two or more rows of the belt assemblies 204 arranged in the sheet transport direction. First and second belt support assemblies 204 spaced apart in the sheet transport direction can be seen in FIG. 36, and a plurality of transversely spaced belt assemblies can be seen in FIG. 44. A first air-knife assembly 216 and a second air knife assembly 218 are also shown in FIG. 36.

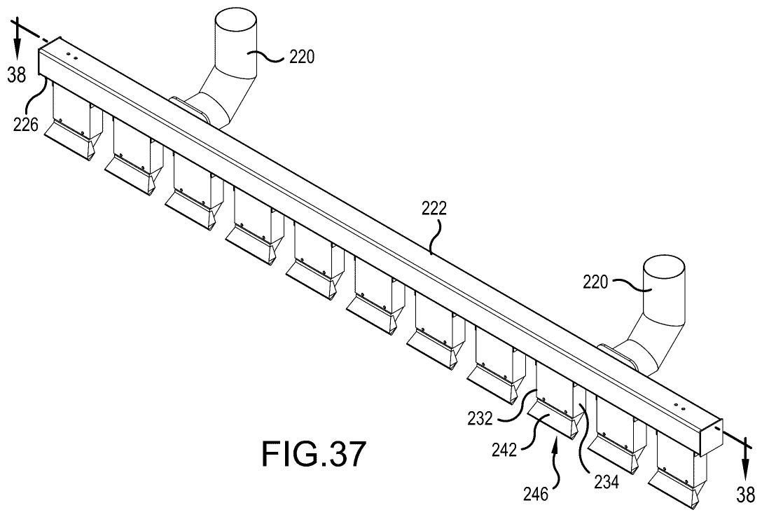

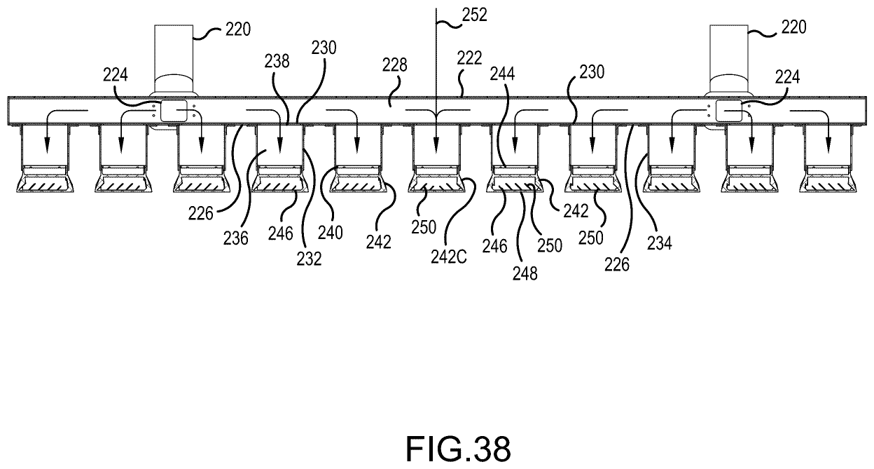

FIGS. 37 and 38 show the air knife assembly 218 removed from the conveyor 200 for illustration purposes. The assembly 218 includes first and second ducts 220 for delivering pressurized air to a conduit 222 via duct outlets 224. In the present disclosure, the conduit 222 has a square or rectangular cross section, but conduits having different cross sections can be used if desirable based on the environment in which the air knife assembly is used. As can be seen in FIG. 38, the conduit 222 has a side wall 226 and an interior 228 and a plurality of conduit outlets 230 in the side wall 226. A plurality of housings 232 each have at least one side wall 234 that defines an interior 236, an entrance aperture 238 connected to one of the conduit outlets 230 and an exit aperture 240.

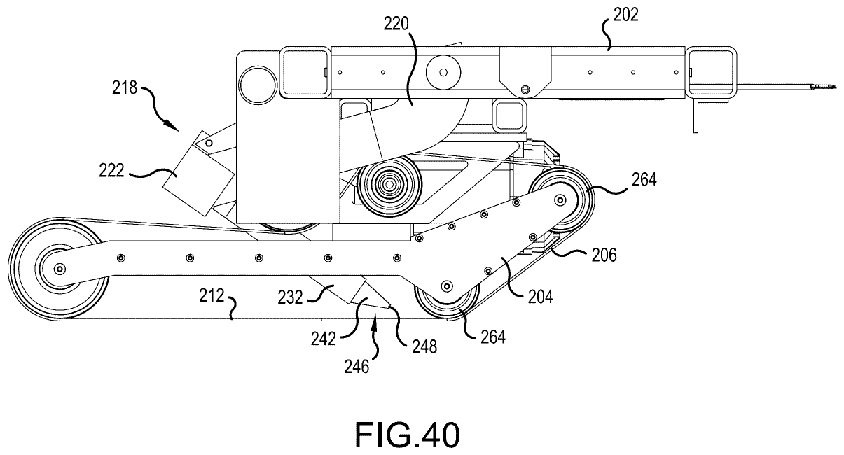

A nozzle 242 is connected to each of the exit apertures 240 of the housings 232 for increasing the speed of air exiting the nozzle 242. Each of the nozzles 242 has an entrance end 244 inserted into or otherwise connected to the exit aperture 240 of a housing, and a tapered exit end 246 (see, e.g., FIG. 40) having a slot-like opening 248 so that air exiting the opening 248 forms a high velocity sheet of air. A plurality of baffles 250 are located at the exit end 246 and angled to direct air exiting the opening 248 at a desired angle relative to a longitudinal centerline of the housing 232.

The ducts 220, conduit 222, housings 232, and nozzles 242 are shown as being formed of sheet metal connected together in a substantially air-tight manner so that air from the ducts 220 is guided to the openings 248 with minimal loss. However, one or more of the ducts 220, conduits 222, housings 232, and nozzles 242 could be extruded from plastic or metal or formed from any other materials or combinations of materials suitable for carrying and guiding pressurized air (or other gas).

With reference to FIG. 38, the baffles 250 are angled at a 45° angle relative to an imaginary center plane 252 that divides the conduit 222 into two halves so that all baffles to one side of the center plane 252 are angled in one direction (e.g., to the left) and all baffles to the other side of the center plane 252 are angled in the opposite direction (e.g., to the right). The disclosure, however, is not limited to the use of baffles at a 45° angle, and other angles and/or combination of baffle angles could be used when appropriate. The baffles of the nozzle 242C located in the center of the air knife assembly 218 are also angled to the left and right of the center plane 252 which passes through the nozzle 242C so that this center nozzle 242C directs air in two opposite directions.

When mounted to the upper deck 202 of the conveyor 200, the air emitted from all nozzles 242 at the angles shown tends to blow scrap or other debris on sheets of material in the sheet transport path 214 away from the longitudinal center line of the sheet transport path 214. This angled air flow makes it more likely that the scrap will be moved off the tops of sheets of material in the sheet transport path so that it can fall between the support wheels 210 rather than remain trapped between the belts 206 and the support wheels and/or between the belts 206 and sheets of material moving through the conveyor 200.

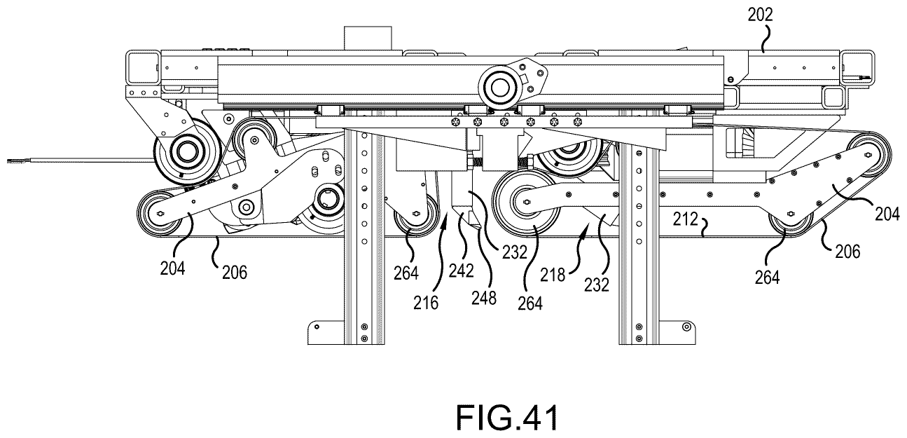

The air knife assembly 218 allows the nozzles to be located and specific air flows to be achieved in desired positions adjacent to the belts 206 without the need to insert a conduit through the interiors of the closed loops formed by each of the belts 206. The disclosed configuration thus allows for the use of an air knife assembly in conveyors in which the use of a conventional air knife would be impossible or impracticable. FIG. 41 shows that an air knife assembly 216 can be located between two belt support assemblies 204 that are spaced apart in the sheet transport direction and or that an air knife assembly 218 can be located between two belt support assemblies 204 that are spaced apart in the transverse direction, partially hiding the air knife assembly 218 in the view of FIG. 41. The locations of two air knife assemblies 216, 218 relative to two belt support assemblies can also be seen in FIG. 36.

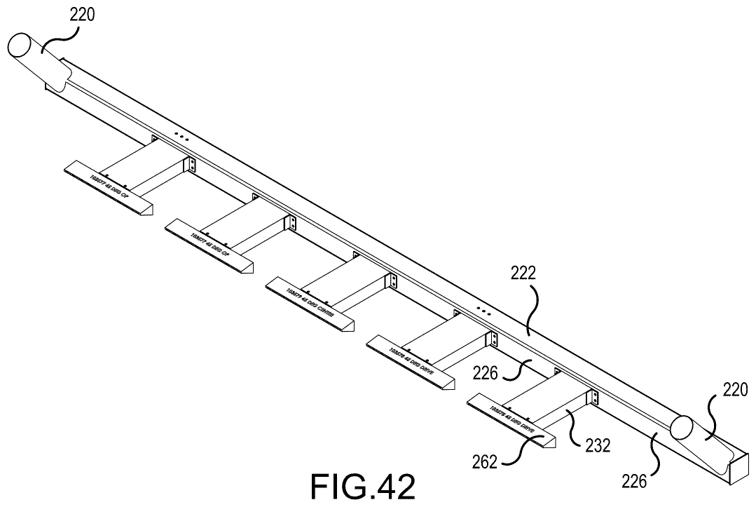

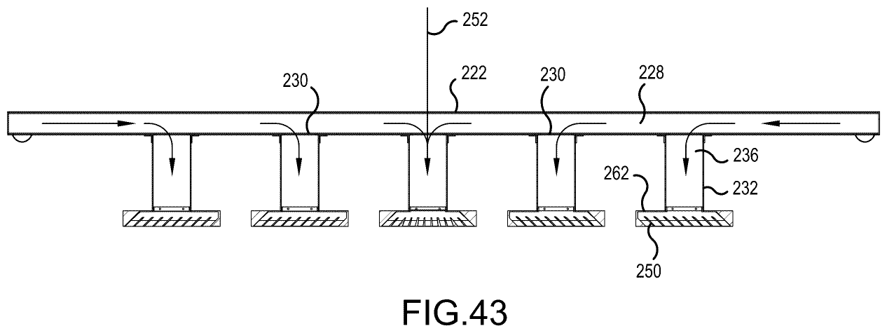

A second embodiment of an air knife assembly 260 is illustrated in FIGS. 42-44. In this embodiment, elements common to the first embodiment are identified by like reference numerals. The air knife assembly 260 differs from the air knife assembly 218 in that the nozzles 262 of the air knife assembly 260 are wider in the transverse direction so that each end of the nozzle can extend into the closed loop formed by each of the belts 206 as shown in FIG. 44. In this manner, the air emitted from the nozzles 262 can be directed not only against the tops of the sheets of material moving along the sheet transport path 214 but also against the insides of the closed loops formed by the belts 206. Angled baffles 250 inside the nozzles 262 can be seen in FIG. 43.

Scrap in a conveyor, when dislodged from the surface of the sheets of material in the sheet transport path 214 may not fall directly downward and out the conveyor. Instead, turbulent air inside the conveyor may lift the scrap above the sheet transport path and cause the scrap to become trapped between the belts 206 and the guide wheels 264 that support them. This can lead to jams or even cause the belts 206 to come off the guide wheels 264. Extending portions of the nozzles 262 directly over the belts 206 inside the closed loop formed by each of the belts may better dislodge scrap than the nozzles 242 of the air knife assembly 218 which are slightly transversely offset from the belts.

The present invention has been described herein in terms of presently preferred embodiments. Additions and modifications to these embodiments will become apparent to persons of ordinary skill in the art upon a reading of the foregoing disclosure. It is intended that all such modifications and additions for a part of the present invention to the extent they fall within the scope of the several claims appended hereto.

What is claimed is:

1. An air knife comprising:
at least one housing having a first end, a second end spaced from the first end in a longitudinal direction, a side wall extending from the first end to the second end, an interior, an entrance aperture configured to be connected to a source of pressurized air to increase a pressure of air inside the at least one housing and an exit aperture,
a nozzle at the exit aperture, the nozzle having a nozzle inlet in fluid communication with the exit aperture, a nozzle outlet spaced from the nozzle inlet, and a nozzle interior, and
a plurality of baffles in the nozzle interior, each of the baffles having a first end at the nozzle inlet and a second end at the nozzle outlet,
wherein each of the baffles is angled relative to the longitudinal direction.

2. The air knife according to claim 1,
wherein the nozzle interior is tapered between the nozzle inlet and the nozzle outlet such that a width of the nozzle outlet is less than a width of the nozzle inlet.

3. The air knife according to claim 2,
wherein the nozzle is formed separately from the side wall and is attached to the side wall at a joint.

4. The air knife according to claim 2,
wherein a first subset of the baffles is angled at a first angle relative to the longitudinal direction and a second subset of the baffles is angled at a second angle relative to the longitudinal direction.

5. The air knife according to claim 4,
wherein the first angle is equal and opposite to the second angle.

6. An air knife assembly including:
a conduit having an interior, and
a plurality of the air knives according to claim 2 connected to the conduit with the first end of each of the housings in fluid communication with the interior of the conduit.

7. The air knife assembly according to claim 6,
wherein the plurality of the air knives includes a first air knife and a second air knife, and
wherein the baffles of the first air knife are angled a first angle and the baffles of the second air knife are angled at a second angle different than the first angle.

8. A conveyor comprising:
a lower conveyor deck having at least one support surface;
an upper conveyor deck including at least one belt support assembly;
a drive configured to move the at least one support surface to move objects supported by the at least one support surface in a downstream direction; and
an air knife according to claim 2 mounted to the upper conveyor deck such that the longitudinal direction of the housing is perpendicular to the downstream direction and such that the nozzle outlet faces the at least one support surface to direct air emitted from the nozzle outlet against the at least one support surface.

9. An air knife assembly comprising:
a conduit having at least one wall and a plurality of openings in the at least one wall,
a first air knife comprising:
a first housing having an entrance aperture connected to a first one of the plurality of openings and having an exit aperture, and
a first nozzle having an interior, an inlet in fluid communication with the exit aperture of the first housing, and a plurality of first baffles in the interior of the first nozzle and angled in a first direction, and
a second air knife comprising:
a second housing having an entrance aperture connected to a second one of the plurality of openings and having an exit aperture, and
a second nozzle having an interior, an inlet in fluid communication with the exit aperture of the second housing, and a plurality of second baffles in the interior of the second nozzle angled in a second direction.

10. The air knife assembly according to claim 9,
wherein the first direction is opposite the second direction.

11. The air knife assembly according to claim 10,
including:
a third housing having an entrance aperture connected to a third one of the plurality of openings, the third opening being located between the first opening and the second opening, and
a third nozzle having an interior, an inlet in fluid communication with the exit aperture of the third housing, and a plurality of third baffles in the interior of the first nozzle,
wherein a first subset of the plurality of third baffles is angled in the first direction and a second subset of the plurality of third baffles is angled in the second direction.

12. The air knife assembly according to claim 11,
wherein the conduit has a longitudinal centerline,
wherein an imaginary plane extends perpendicular to the longitudinal centerline,
wherein the first direction is at a first angle to the imaginary plane,
wherein the second direction is at a second angle to the imaginary plane, and
wherein the first angle is equal in degree and opposite in sign to the second angle.

13. The air knife assembly according to claim 12,
wherein the first angle is from 30 to 60 degrees.

14. The air knife assembly according to claim 13,
wherein the first angle is about 45 degrees.

15. A conveyor comprising:
a lower conveyor deck having at least one support surface;
a drive configured to move the at least one support surface to move objects supported by the at least one support surface in a downstream direction;
an upper conveyor deck including a plurality of belt support assemblies each supporting an upper guide belt over the lower conveyor deck to define with the at least one lower conveyor deck a sheet transport path through the conveyor, the plurality of upper guide belts including a first upper guide belt and a second upper guide belt and a third upper guide belt spaced apart in a direction perpendicular to the sheet transport direction, and
an air knife according to claim 10 mounted to the upper conveyor deck above the lower conveyor deck such that the first housing extends between the first upper guide belt and the second upper guide belt and such that the first nozzle and the second nozzle are directed toward the lower conveyor deck.

16. The conveyor according to claim 15,
wherein each of the plurality of upper guide belts forms a closed loop, and
wherein a first portion of the first nozzle extends into the closed loop formed by the first upper guide belt such that air emitted from the first portion of the first nozzle is directed against the first upper guide belt.

17. The conveyor according to claim 16,
wherein a second portion of the first nozzle extends into the closed loop formed by the second upper guide belt such that air emitted from the second portion of the first nozzle is directed against the second upper guide belt.

18. The conveyor according to claim 15, including:
a third housing having an entrance aperture connected to a third one of the plurality of openings, the third opening being located between the first opening and the second opening,
a third nozzle having an interior, an inlet in fluid communication with the exit aperture of the third housing, and a plurality of third baffles in the interior of the first nozzle,
wherein a first subset of the plurality of third baffles is angled in the first direction and a second subset of the plurality of third baffles is angled in the second direction.
